(19) United States
(12) Patent Application Publication
(10) Pub. No.: US 2006/0053028 A1
(43) Pub. Date: Mar. 9, 2006

(54) Methods and systems for generating and collecting real-time experiential feedback on the operation of fishing equipment

(76) Inventor: Robert J. Congel, Fayetteville, NY (US)

Correspondence Address: JEFFREY L. BRANDT;c/o PORTFOLIO IP, P.O. BOX 52050, MINNEAPOLIS, MN, 55402, US

(21) Appl. No.: 11/212,501

(22) Filed: Aug. 26, 2005

Related U.S. Application Data
(60) Provisional application No. 60/607,058, filed on Sep. 3, 2004.

(51) Int. Cl. G06Q 99/00

(52) U.S. Cl. 705/1

(57) ABSTRACT

Methods and systems for generating real-time feedback on the use of fishing equipment. Data collection including user input enable the present invention to monitor and receive information relating to fishing equipment use and success rates under differing environmental conditions and with specific fish species, while providing users access to a broad range of desired fishing experiences.

### BACKGROUND

Currently, no good method is known to the inventor for receiving real-time feedback relating to the operation of and success or failure of fishing equipment. Fishing is generally a remote and often a solitary event. Even when fishermen share a common geographical location, each tends to fish independently of the others around him. Equipment and tackle are often owned by the individual. Bait is often selected individually from several choices of live bait, prepared bait or artificial lures and may be changed frequently.

When commercial businesses such as fishing equipment manufacturers, retailers and bait stores make recommendations to customers, the recommendations are often anecdotally based. Equipment recommendations may be based on relatively little or no feedback from prior customers. Recommendations on tackle and bait are often based again on anecdotal feedback as to what was related to have been successful for recent customers.

In the instances where fishing individuals are monitored, the usual metric is the result of the fishing event—catching the desired fish or not—and not on monitoring and determining the performance of the fisherperson or the equipment during the event. When performance data are gathered, they are opinion and not fact based and they often arise from a small sample.

The lack of available and timely data relating to fishing success with specific products creates difficulties for commercial businesses of many different types. Fishing equipment developers have relatively limited feedback and experiential or detailed experimental data on which to base new product developments and improvements. Resellers of equipment and bait or lures are similarly limited in their ability to accurately advise customers.

### SUMMARY OF THE INVENTION

The present invention provides methods and systems for providing real-time feedback on the use and particularly the success or failure of fishing equipment to interested parties. Using readily available technology and relatively limited controls on activities, the present invention enables commercial parties to monitor and receive information relating to fishing equipment use and success rates under differing environmental conditions and with specific fish species, while users are still provided access to a broad range of desired fishing experiences. The result is better information for use by businesses and a better experience for customers.

### DESCRIPTION OF THE DRAWING FIGURES

These and other objects, features and advantages of the invention will be apparent from a consideration of the detailed description of the invention when read in conjunction with the drawing Figures, in which:

FIG. 1 is a block diagram of a fishing equipment system implemented in accordance with the present invention; and

FIG. 2 is a flow chart describing a process for collecting real-time information relating to the operation of fishing equipment in accordance with the present invention.

### DETAILED DESCRIPTION OF THE INVENTION

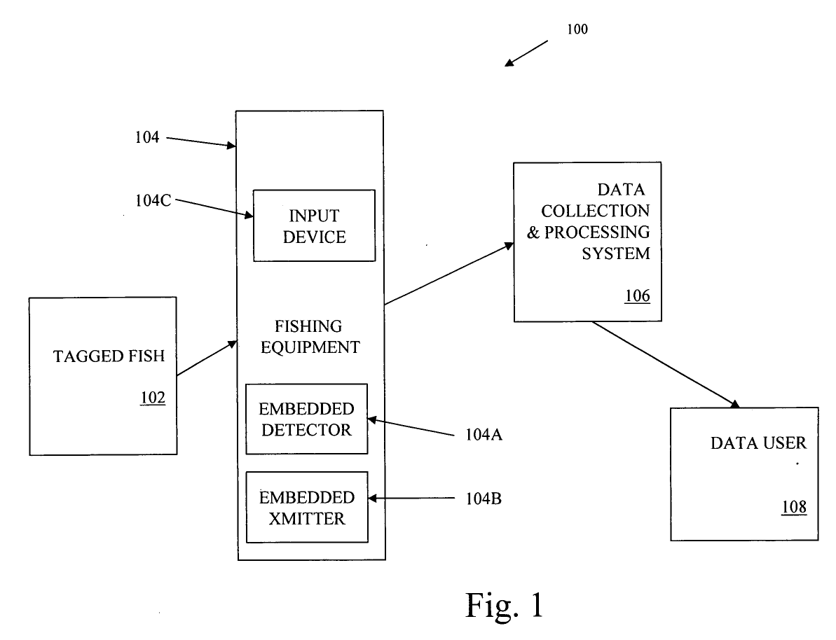

With reference to FIG. 1, there is shown a system 100 for facilitating the collection of real-time information relating to the operation and success or failure of fishing equipment. System 100 includes a geographically disperse fish population 102 each tagged with an identification tag containing detectable information about the fish. Fishing equipment such as a rod and reel combination 104 includes a detector 104A capable of sensing the information on a tagged fish 102, a transmitter 104B and may or may not include a direct user input device 104C such as a keypad. Transmitter 104B is capable of transmitting a unique fishing equipment identifier, the tag information on the fish and the user information to a remote data collection and processing system 106. The data processing system is connected to transmit received data to one or more data end-users 108.

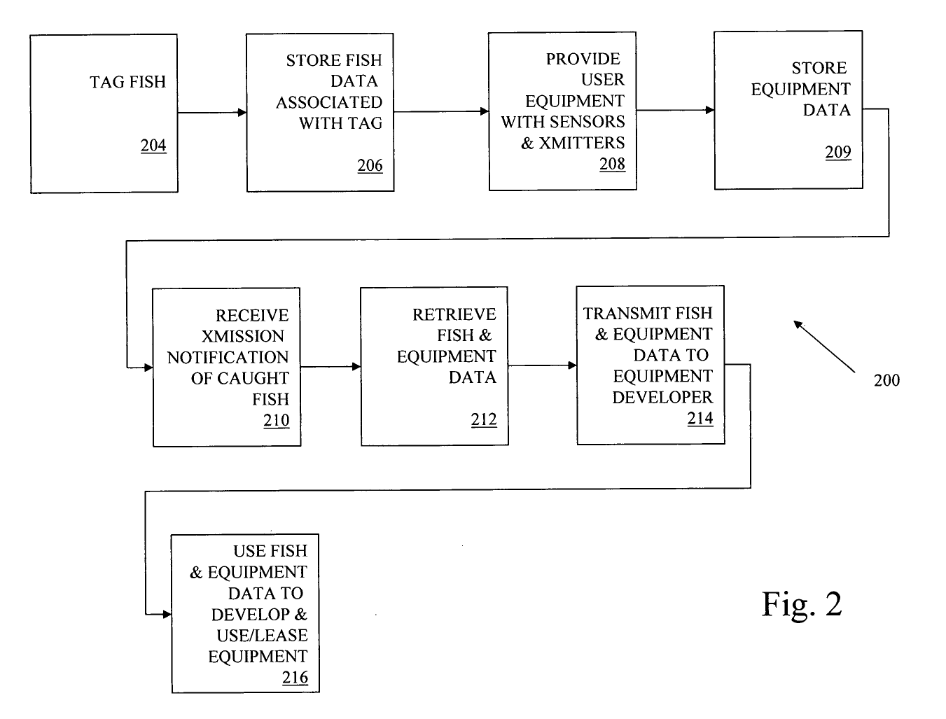

With reference to FIG. 2 there is shown a process 200 for real-time collection of fishing equipment usage information. Initially, as noted above, fish are tagged and released over a geographically disperse area (step 204). In accordance with the invention, the area selected for releasing tagged fish is sufficiently large so as to give a fisherman/user the opportunity to experience a real fishing experience. The area may be, for example, a single lake and/or many bodies of water over a larger area.

Data is stored in a data collection and processing system 106 relating to the tagged fish (step 206). Exemplary data includes: fish type, size, sex, location, body of water and other factors of interest. It will be understood that the data not only relates to the fish as of the date of tagging, but can also be readily processed by system 106 based upon dates, climate, geography and other readily determined conditions to accurately estimate the size of the tagged fish on any day the tag is sensed and the fish identified. Further, the tag can be made to automatically transmit information on the specific fish, its environment and location at any given time. This data can be stored and analyzed for trends in the fishing environment and used to help locate a given fish at any time for any purpose.

Continuing with FIG. 2, users of equipment, whether purchasers or renters, are provided equipment 104 having embedded detector 104A, embedded user input device 104C and embedded data transmitter device 104B. The user is provided instructions on how to operate input device 104C to input information of interest, such as: the type of bait, lures and tackle used, demographic data defining the user and other data of interest (step 208). A further embodiment is that the transmitter on the equipment is set to self determine and record the information requiring no user input. The sales data relating to the equipment itself and the purchaser of the equipment is collected and stored in system 106 or elsewhere as of the sales date of the equipment (step 209).

When the fishing equipment 104 is used and a tagged fish is caught, the tag information is sensed by detector 104A. Optionally, the user may input some or all of the above-described user information as well as additional information of interest. The tag and user information along with the equipment identifier is transmitted to system 106 (step 210) where the original stored information relating to the equipment and purchaser is also retrieved (step 212). In one embodiment, the data is transmitted to an equipment developer (step 214) for use in developing equipment (step 216). Many other recipients and users of the data will now be apparent, including for example: bait and tackle sellers, wildlife management parties, recreation companies, fishing professionals, fishing guides and numerous others.

Users may be motivated to provide data input using interface 104C through the offer of rewards, such as updated fishing information or retail discounts.

In one embodiment, the invention is used to facilitate a tournament. The data user 108 may be the tournament manager. The tournament data may be displayed in real-time during the tournament, even over a dispersed geographic area. The beneficial results will be numerous including, for example: encouraging the use and/or sale of ‘successful’ equipment and bait, identifying to all participants the current leaders in the tournaments, identifying to equipment suppliers and sellers the most successful equipment, and others as will now be apparent to the reader.

There has thus been provided methods and systems for collecting real-time fishing information, over a widely disperse geographic area, without unduly limiting the options of fishermen/users/customers. The invention has the benefit of providing valuable information to equipment developers, manufacturers and retailers while also enhancing the fishing experience of the fishermen.

What is claimed is:

1. A system for collecting real-time fishing equipment information, including:
a piece of fishing equipment including a detector for detecting information from a tagged fish, an input device for a user, and a transmitter;
a data collection system for storing information relating to the tagged fish and the piece of fishing equipment; and
the data collection system further operative to receive from the transmitter transmitted information including an identifier of the fishing equipment, tag information from a caught fish and any data entered by the fishing equipment user.

2. A method of collecting real-time fishing equipment information, including:
releasing tagged fish into a realistic fishing environment;
providing fishing equipment to a fisherman, the fishing equipment including a sensor for reading the tags on the fish and a transmitter for transmitting an identifier of the equipment and the fish tag information to a remote system;
receiving into the remote system an indication of a caught fish including the equipment identifier and the tag information of the caught fish;
retrieving, using the equipment identifier, information relating to the fishing equipment;
retrieving, using the tag information, information relating to the caught fish; and
transmitting the equipment information and caught fish information to a third party.
